(19) United States
(12) Patent Application Publication
(10) Pub. No.: US 2006/0083153 A1
(43) Pub. Date: Apr. 20, 2006

(54) Method of producing a product comprising a carrier for audio and/or video digital data, of the audio video compact disc type, and obtained compact disc

(76) Inventors: Jacques Pitoux, Toulouse (FR); Michel Pitoux, Bourrouillan (FR); Jean-Marc Deleuze, Urgose (FR)

Correspondence Address: YOUNG & THOMPSON, 745 SOUTH 23RD STREET, 2ND FLOOR, ARLINGTON, VA, 22202, US

(21) Appl. No.: 10/974,755

(22) Filed: Oct. 28, 2004

(30) Foreign Application Priority Data
Oct. 20, 2004 (FR) 04 11131

(51) Int. Cl. G11B 17/04

(52) U.S. Cl. 369/199

(57) ABSTRACT

Method of producing a product including a carrier for audio and/or video digital data, of the audio or video compact disc type, by: printing on the surface of a blank compact disc opposite the reading surface, an informative picture relating to audio and/or video digital data which are intended to be recorded subsequently on the compact disc, and offering the printed blank compact disc for sale. The compact disc carries, on an opposite face, a printed informative picture intended to be recorded subsequently. The compact disc is free of any digital data which are intended to be recorded subsequently, and the product is accessible to a server via a digital telecommunications network, of the internet, with a view to downloading from the server, the data intended to be recorded on the printed blank compact disc.

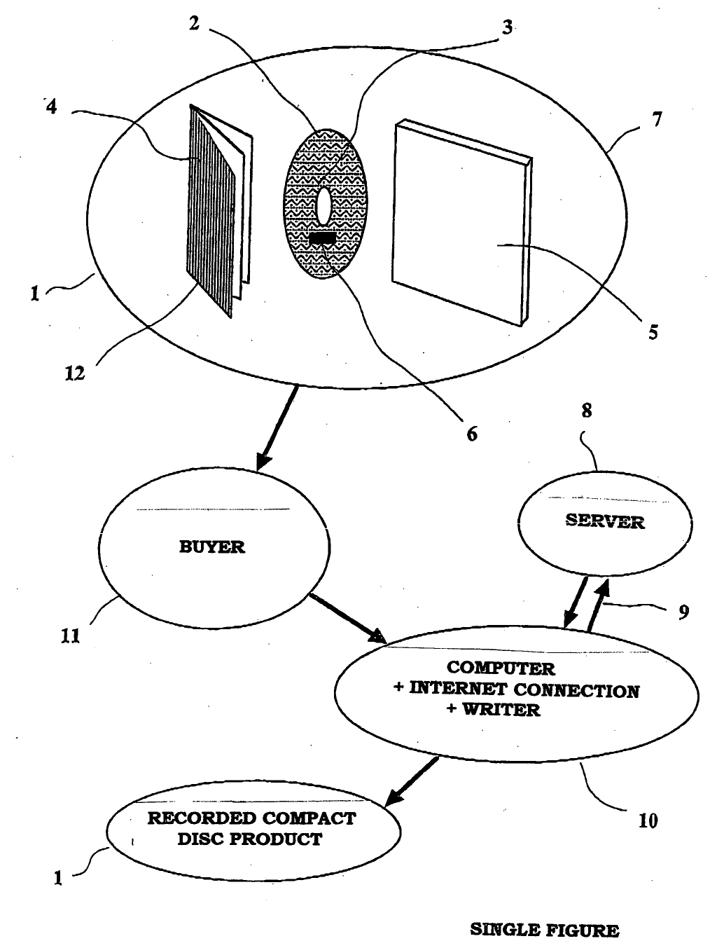

The present invention relates to the field of carriers for audio and/or video digital data, of the audio or video compact disc type, more particularly to their method of production, packaging and marketing.

The current problems which the compact disc industry encounters are known, in part due to the development of downloading, in particular free illegal downloading from the internet. The consequence of this practice involves, essentially according to the representatives of the audio compact disc industry but likewise of the video compact disc industry, and of the game and software disc industry, a very significant reduction in sales.

The disc industry has reacted to this problem, in particular by proposing pay downloading sites on the internet, of compressed digital files, essentially of music, of the mp3 type.

However, pay downloading, which is effected normally in the home by the buyer, has the disadvantage of not being attractive from the point of view of the packaging of the final product, for which the buyer must himself produce, by hand or in the form of photocopies of more or less high quality, and in a sometimes illegal manner, the labels or informative script relating to the data recorded on the disc, which are associated with the compact disc itself, directly on the disc and/or on the paper documents accompanying the disc box and inserted at appropriate places for this purpose on the box. The result is dissatisfaction for the consumer with respect to a product for which he has nevertheless paid a not insignificant price.

As a consequence, pay downloading remains very marginal faced with free downloading at this moment.

The present invention intends essentially to reduce these disadvantages. More precisely, it comprises a method of producing a product comprising a carrier for audio and/or video digital data, of the audio or video compact disc type, characterised in that it comprises:
printing on the surface of a blank compact disc opposite the reading surface, an informative picture relating to audio and/or video digital data which are intended to be recorded subsequently on said compact disc,
offering said thus printed blank compact disc for sale.

The production and offer for sale of a blank compact disc but comprising a printed informative picture relating to data which will be recorded subsequent to being put on sale, allows the offer commercially of a product which is ready to record data, for example downloaded, which is attractive and appealing from an aesthetic point of view since once the data are recorded, the final product will be visually similar, and even identical, to the industrial compact disc sold commercially at present and comprising data recorded after being put on sale, either by pressing or by writing. Hence, the product proposed according to the present invention allows the editor a saving in manufacturing costs in that it allows costs relating to the recording of the data to be avoided. By blank compact disc there is meant here a compact disc which is free of all data which are intended to be recorded subsequently and for which the informative picture has been printed on the compact disc; the blank compact disc will however be able to comprise any recording of data which are intended for use of the disc by a reader, existing on any blank disc which is currently available for sale. By informative picture there is meant any print comprising data relating to the future recording, for example a picture such as is found on recorded compact discs which are sold at present, comprising drawings, photos, script etc.

According to an advantageous feature, the method according to the invention comprises furthermore:
printing informative paper documents relating to said audio and/or video digital data which are intended to be recorded subsequently on said compact disc, and which are able to be inserted at appropriate places on a compact disc box or forming the box itself,
packaging said box, said printed paper documents and said printed blank compact disc in order to prevent inopportune opening of the thus packaged product,
offering said thus packaged product for sale.

This feature allows an extremely attractive complete product to be proposed, comprising all the components of a factory recorded compact disc which is currently sold commercially. By informative paper documents there is meant here all the paper documents traditionally accompanying a compact disc, i.e. the interior booklet slid under tabs in the cover of the disc box, and the paper pictures inserted between the boxed elements forming the box itself, i.e. in principle one or two pictures according to whether the box is opaque or transparent respectively. By paper documents there is meant likewise any other form of document forming the direct packaging of the compact disc, in particular in paper or card, comprising direct informative prints.

According to an advantageous feature, the method according to the invention comprises furthermore recording, subsequent to said offer for sale of the product, said digital data by writing on said thus printed blank compact disc.

This feature allows very flexible subsequent recording, which is able to be effected by an individual because it can be effected by a writer, a device which is fitted in most home computers.

According to an advantageous feature, the step comprising recording, subsequent to said offer for sale of the product, said numerical data by writing on said thus printed blank compact disc, is effected by the buyer of the printed blank compact disc or by an authorised person.

This feature in fact proposes production of the compact disc in two distinct steps: a first step, termed industrial by the editor of the disc who edits and puts on sale in fact a non-transferable blank disc of data stamped with the non-transferable symbol of the disc, and a second step which can be termed hand-crafted, which step is effected by the buyer of the industrial product. By authorised person there is meant here any person possessing the knowledge of access means to the server, by means of the buyer of the blank disc.

According to an advantageous feature, the method according to the invention comprises furthermore associating with said product before its offer for sale, means of access to a server via a digital telecommunications network, of the internet or analogous type, with a view to downloading from said server said audio and/or video digital data which are intended to be recorded on said blank compact disc.

This feature allows the recording which will be effected on the blank disc after its sale to be checked, and thus allows this recording to be rendered legal. In fact, the royalties will be paid during purchase of the blank disc by the buyer of the latter, in the same way as he pays these royalties when currently buying a recorded disc. The editor of the non-transferable blank disc will be able for example to make an internet server available to the buyers who will come to download the digital data which are appropriate for the bought blank disc and correspond to the informative picture which it carries, thanks to the access means associated for example with the compact disc. An advantage of the proposed invention is that the purchase in a shop of the blank compact disc can be made by any means of payment, whilst on the internet, for the payment online of a downloading in particular, only bank cards are accepted. It would be advisable to note likewise that downloading can be “free” because the royalties have been paid at the moment of purchase of the blank disc, which avoids all the disadvantages of payment online of pay downloading, in particular the requirement to have a bank card.

According to an advantageous feature, said means of access to a server allow one downloading, and one only, from said server.

This feature contributes to the check of the legality of the production method according to the invention, by allowing only one single downloading of the data, the royalties of which have been paid at the moment of purchase of the blank compact disc.

According to an advantageous feature, said means of access to a server are made invisible to the eye on said product and are able to be uncovered following an irreversible voluntary operation of the buyer or an authorised person.

This feature contributes to a reduction in fraud, by proposing a solution for preventing a third party who is not buying the blank disc, and who therefore acquires no right of access for downloading data made possible by knowledge of the means of access to the server.

According to an advantageous feature, the method according to the invention comprises printing on the surface of the blank compact disc opposite the reading surface, an informative picture relating to digital audio and/or video data which are intended to be recorded subsequently on said compact disc, by screen printing.

This feature gives the product an industrial presentation of identical quality to recorded discs which are sold commercially at present.

The invention relates likewise to a product comprising a carrier for audio and/or video digital data, of the audio or video compact disc type, characterised in that the compact disc carries on the surface opposite the reading surface, a printed informative picture relating to audio and/or video digital data which are intended to be recorded subsequently on said compact disc, in that said compact disc is free of any audio and/or video digital data which are intended to be recorded subsequently, and in that said product comprises means of access to a server via a digital telecommunications network, of the internet or analogous type, with a view to downloading from said server, said audio and/or video digital data which are intended to be recorded on said thus printed blank compact disc.

According to an advantageous feature, the product according to the invention comprises furthermore:
informative paper documents relating to said audio and/or video digital data which are intended to be recorded subsequently on said compact disc, and which are able to be inserted at appropriate places on a compact disc box or forming the box itself,
an audio or video compact disc box,
a packaging containing said box, said printed informative paper documents and said printed blank compact disc.

According to an advantageous feature, said means of access to a server comprise a code for access to said server.

This feature proposes an example for a match between the sold blank disc and the request for downloading corresponding data, by the server or by an analogous method, as being a downloading authorised by the purchase of the blank disc and means of access to the server, a downloading which can therefore be effected. The access code likewise allows the user to remain anonymous during downloading. The access code allows furthermore counterfeiting of the product according to the invention to be combated because the disc editor alone has all the access codes distributed with the blank discs, a defined access code being associated with one defined non-transferable blank disc and one alone. By way of example, an access code can be formed by an identification number for each copy of a printed blank disc which is offered for sale.

According to an advantageous feature, said means of access to a server are recorded on said compact disc.

This feature proposes an example for choice of provision of access means, associated with the disc itself, a feature which is particularly important for the packaging of reduced discs, or to ensure a direct relation between the bought blank disc and downloading.

According to an advantageous feature, said means of access to a server are printed on at least one of said informative paper documents.

This feature allows provision in an alternative manner of the means of access to the server, by not associating them directly with the disc but to one of the accessories accompanying it advantageously, according to requirements.

According to an advantageous feature, said means of access to a server are protected by a masking means which makes them invisible to the eye.

The masking means allows advantageously pirating of the product according to the invention to be combated by not allowing that a non-authorised third person can uncover the means of access to the server and download the data without having previously paid the royalties whilst buying the blank disc corresponding to these data.

According to an advantageous feature, said masking means comprises a product covering said means of access to a server, which is able to be removed in an irreversible manner from its carrier, then leaving said access means visible to the eye.

This feature allows identification of a compact disc, the means of access to the server of which have been forced or stolen. It thus allows a distributor to withdraw from the sale circuit a blank disc which would have been degraded in that the means of access to the server would have been stolen or forced by a non-authorised third party, and likewise allows prevention of downloading of the data corresponding to the blank compact disc, the means of access to the server of which have been stolen or forced, for example by preventing downloading, in particular by invalidating the access code when the access code formulated by the applicant for downloading is identified as being the one which has been forced or stolen.

Other features and advantages will appear in the text which follows of examples of method embodiments and product embodiments according to the invention, accompanied by the annexed drawing, non-limiting examples given by way of illustration.

The single drawing represents schematically a diagram illustrating an embodiment of a method for producing a product comprising a carrier for audio and/or video digital data, of the audio or video compact disc type, and an embodiment of a product derived from this method.

The method for producing a product 1 comprising a carrier 2 for audio and/or video digital data, of the audio or video compact disc type, comprises:
printing on the surface of the blank compact disc 2 opposite the reading surface, an informative picture 3 relating to audio and/or video digital data which are intended to be recorded subsequently on the compact disc 2, this printing being able for example to be effected advantageously by screen printing,
the method furthermore advantageously comprising:
associating with the product 1 before its offer for sale, means of access 6 to a server 8 via a digital telecommunications network 9, of the internet or analogous type, with a view to downloading from the server 8, audio and/or video digital data which are intended to be recorded on the blank compact disc 2,
printing informative paper documents 4 relating to audio and/or video digital data which are intended to be recorded subsequently on the compact disc 2, and which are able to be inserted at appropriate places on a compact disc box 5 in any known manner,
packaging the box 5, the printed paper documents 4 and the printed blank compact disc 2, by means of a packaging 7 in any known manner in order to prevent inopportune opening of the thus packaged product,
offering the thus packaged product 1 for sale,
recording, subsequent to the sale of the product 1, digital data by writing on the thus printed blank compact disc, this operation being effected advantageously by the buyer 11 of the printed blank compact disc 2 (or in the described example, of the product 1 comprising this disc) or a person authorised by the latter.

The printing of the informative picture 3 on the blank compact disc 2 can be achieved according to any means and standard known on the subject, for example prints such as appear conventionally on audio or video compact discs of the CD rom, DVD type etc . . . which are recorded and distributed commercially at present. The informative picture can in particular and for example precisely describe the contents of the data which will be recorded subsequently by the buyer of the blank disc, the list of the musical titles for an audio CD, or the chapters and/or the content of a DVD, or simply to mention the title of an album or of a film or of a game etc . . . . The blank compact disc itself on which the print will be effected will be appropriate for recording data for which it is intended, for example a CD-R, CD-RW for future audio recordings, DVD-R, DVD-RW for future video recordings, or analogously.

The means of access 6 to a server 8 via a digital telecommunications network 9 will advantageously allow one single downloading from the server 8 and will furthermore be preferably made invisible to the eye on the product 1 for sale, while nevertheless being able to be uncovered following a voluntary irreversible operation of the buyer, as will be explained further on. The means of access 6 to the server 8 will advantageously comprise a code for access to the server 8, for example a digital code, which will be able to be formed by a single identification number of the sold blank disc 2, printed on the surface of the blank disc which is not dedicated to reading. The editor of the blank disc 2 or any other appropriate person will advantageously hold a list of issued identification numbers, for which the editor or any other appropriate person will advantageously allow a single downloading on the server 8 when one of these numbers is provided during a request for downloading, effected from a remote computer 10, for example that of the buyer 11. Once the digital data are downloaded, the operator will then be able to record these data on the blank disc by writing in order to be in possession of a product which is quasi identical, or even identical, to the products of this type which are factory recorded, by pressing or by writing, currently available commercially.

It is quite possible to imagine, in the case of failure of recording of the data by the user, and therefore in the case of the necessity of having to recommence the recording by writing on another carrier, that the editor or a distributor provides a buyer, who presents the appropriate proof of such a “botching” (for example the disc which is the subject of the failed recording), giving this buyer a new printed blank disc so that he can recommence the operation of recording data on the latter. According to the level of failure in the process, for example, downloading or recording, any appropriate solution will be able to be proposed to the buyer, for example provision of a new printed blank compact disc comprising a new code for access to the server in the case of failure of the downloading, or provision of a new printed blank disc without a code in the case of failure of the writing.

The printed informative paper documents 4 relating to audio and/or video digital data which are intended to be recorded subsequently on the compact disc 2, and which are able to be inserted at appropriate places on a compact disc box 5 in any known manner, will be able to be any document of the currently known type distributed with the recorded commercial discs, for example a booklet 12 to be inserted in the cover of the disc box and one or more pictures (not represented) to be inserted between the elements of the carrier box 5 of the disc 2. The paper documents will be able to be inserted for example behind the tabs of the cover of the box 5 for the booklet 12 and sandwiched between the carrier plate of the disc and the back of the box for the picture or pictures provided for this purpose and intended to be visible from the exterior and at the back of the box 5.

The association of the access means 6 with the product 1 can be made on the disc 2 itself as represented in the Figure but can be made alternatively on the printed documents 4, the booklet 12 for example. Preferably, the access code will not be visible from the exterior of the product 1 and will be accessible by scratching for example, such an operation being difficult to reverse. Hence, any “pirated” downloading will be detectable from the product 1, which will allow an authorised person to act with a view in particular to preventing this downloading.

The packaging 7 of the product 1 for sale will advantageously be effected in any known manner, for example in a manner similar to that for packaging recorded compact discs which are sold in a conventional manner commercially at present, i.e. with a plastic packaging. Care will be taken that the access code is not visible from the exterior of the packaged product 1 if this access code is not itself protected by a masking means.

The product 1 will be put on sale at any compact disc distribution point, in particular large surfaces, specific or not, and will need preferably to differ from a similar product which is known but not recorded, for example by an attractive price, but likewise by the informative that the sold compact disc is free of data corresponding to the printed pictures accompanying the disc in the packaging.

The production process of the product 1 is achieved by recording, subsequent to the sale of the product 1, digital data obtained by downloading thanks to the access code 6, advantageously by writing on the printed blank compact disc, this operation being effected advantageously by the buyer 11 of the printed blank compact disc 2, i.e. in the described example, the buyer of the product 1 comprising this disc, or a person authorised by the latter, for example on the computer 10 which has served for downloading if it is provided with an appropriate writer.

The method according to the invention as described above is very suitable for carriers of the compact disc type, i.e. audio compact discs of the audio CD type, video compact discs of the DVD type, video game compact discs, software compact discs etc . . . .

1. Method of producing a product comprising a carrier for audio and/or video digital data, of the audio or video compact disc type, characterised in that it comprises:
printing on the surface of a blank compact disc (2) opposite the reading surface, an informative picture (3) relating to audio and/or video digital data which are intended to be recorded subsequently on said compact disc,
offering said thus printed blank compact disc for sale.

2. Method according to claim 1, characterised in that it comprises furthermore:
printing informative paper documents (4) relating to said audio and/or video digital data which are intended to be recorded subsequently on said compact disc (2), and which are able to be inserted at appropriate places on a box (5) of the compact disc or forming the box itself,
packaging said box, said printed paper documents and said printed blank compact disc in order to prevent inopportune opening of the thus packaged product (1),
offering said thus packaged product for sale.

3. Method according to claim 1, characterised in that it comprises furthermore recording, subsequent to said offer for sale of the product (1), said digital data by writing on said thus printed blank compact disc (2).

4. Method according to claim 3, characterised in that the step comprising recording, subsequent to said offer for sale of the product, said digital data by writing on said thus printed blank compact disc (2), is effected by the buyer (11) of the printed blank compact disc or an authorised person.

5. Method according to claim 1, characterised in that it comprises furthermore associating with said product (1), before its offer for sale, means of access (6) to a server (8) via a digital telecommunications network (9), of the internet or analogous type with a view to downloading from said server said audio and/or video digital data which are intended to be recorded on said blank compact disc (2).

6. Method according to claim 5, characterised in that said means of access (6) to a server allow one downloading and one only from said server.

7. Method according to claim 5, characterised in that said means of access (6) to a server are made invisible to the eye on said product and are able to be uncovered following an irreversible voluntary operation by an authorised operator.

8. Method according to claim 1, characterised in that it comprises printing on the surface of the blank compact disc (2) opposite the reading face, an informative picture (3) relating to the audio and/or video digital data which are intended to be recorded subsequently on said compact disc, by screen printing.

9. Product comprising a carrier for audio and/or video digital data, of the audio or video compact disc type, characterised in that the compact disc (2) carries on the face opposite the reading face, a printed informative picture (3) relating to audio and/or video digital data which are intended to be recorded subsequently on said compact disc, in that said compact disc (2) is free of any audio and/or video digital data which are intended to be recorded subsequently, and in that said product (1) comprises means of access (6) to a server (8) via a digital telecommunications network (9) of the internet or analogous type, with a view to downloading from said server said audio and/or video digital data which are intended to be recorded on said thus printed blank compact disc.

10. Product according to claim 9, characterised in that it comprises furthermore:
informative paper documents (4) relating to said audio and/or video digital data which are intended to be recorded subsequently on said compact disc (2), and which are able to be inserted at appropriate places on a box (5) of a compact disc or forming the box itself,
an audio or video compact disc box (5),
a packaging (7) containing said box, said printed informative paper documents and said printed blank compact disc.

11. Product according to claim 9, characterised in that said means of access (6) to a server (8) comprise a code for access to said server.

12. Product according to claim 9, characterised in that said means of access (6) to a server (8) are recorded on said compact disc (2).

13. Product according to claim 10, characterised in that said means of access (6) to a server (8) are printed on one at least of said informative paper documents (4).

14. Product according to claim 9 characterised in that said means of access (6) to a server are protected by masking means making them invisible to the eye.

15. Product according to claim 14, characterised in that said masking means comprises a product covering said means of access to a server, which is able to be removed in an irreversible manner from its carrier, then leaving said access means visible to the eye.
